(19) United States
(12) Patent Application Publication
(10) Pub. No.: US 2026/0151908 A1
(43) Pub. Date: Jun. 4, 2026

(54) MULTI-MOTION SWITCHING CONTROL METHOD AND SYSTEM FOR HUMANOID ROBOT BASED ON IMITATION LEARNING

(71) Applicant: SHANDONG UNIVERSITY, Jinan (CN)

(72) Inventors: Ran SONG, Jinan (CN); Wei ZHANG, Jinan (CN); Honghao LIAO, Jinan (CN); Zhiheng LI, Jinan (CN); Wenhao TAN, Jinan (CN); Xing FANG, Jinan (CN); Xiaolei LI, Jinan (CN)

(21) Appl. No.: 19/403,365

(22) Filed: Nov. 28, 2025

(30) Foreign Application Priority Data
Dec. 2, 2024 (CN) 2024117528136

(51) Int. Cl. B25J 9/16; B62D 57/032

(52) U.S. Cl. CPC B25J 9/1664; B25J 9/163; B25J 9/1633; B62D 57/032

(57) ABSTRACT

Disclosed is a multi-motion switching control method and system for a humanoid robot based on imitation learning, where the imitation learning is performed based on a Generative Adversarial Network, and a sampling probability for each motion skill is dynamically adjusted according to performance of the humanoid robot in executing the motion skill, so that the humanoid robot uniformly masters different motion skills; this enables the humanoid robot to integrate different combinations of motion skills, effectively mitigates the severity of the mode collapse problem, and provides good flexibility and scalability.

### CROSS-REFERENCE TO RELATED APPLICATIONS

The present invention claims priority to Chinese Patent Application No. 202411752813.6, filed with the China National Intellectual Property Administration on Dec. 2, 2024 and entitled “MULTI-MOTION SWITCHING CONTROL METHOD AND SYSTEM FOR HUMANOID ROBOT BASED ON IMITATION LEARNING”, which is incorporated herein by reference in its entirety and constitutes an integral part of the present invention for all purposes.

### TECHNICAL FIELD

The present invention belongs to the field of imitation learning-related technologies, and in particular, to a multi-motion switching control method and system for a humanoid robot based on imitation learning.

### BACKGROUND

The statements in this section merely provide background information related to the present invention and do not necessarily constitute the prior art.

With the increasing popularity of humanoid robots, the demand for their enhanced functionality will continue to grow. One of the main requirements for humanoid robots is to master multiple different motion skills simultaneously, enabling them to better cope with various different scenarios and tasks in real-world applications. This requirement has made the integration of multi-motion skills in humanoid robots a recent research hotspot in the field of motion control for humanoid robots. The integration of multi-motion skills aims to incorporate various different motion skills, such as standing, walking, running, and jumping, into one or more motion controllers of a humanoid robot, enabling it to switch flexibly between these different motion skills.

In the field of motion control for humanoid robots, existing learning-based technologies primarily fall into two mainstream directions: reinforcement learning-based and imitation learning-based methods. Reinforcement learning-based methods exhibit stronger adaptability to the morphology of humanoid robots. The differences between various motion skills are a main reason why existing reinforcement learning-based methods rely on reward engineering. For motion skills with a high degree of similarity, such as walking and running, a similar set of reward functions can often be used to assist in their training and learning. However, for motion skills with significant differences, such as running and jumping, it is often necessary to use different combinations of reward functions during the training process to impose different behavioral constraints on a humanoid robot, thereby ensuring it can learn the correct motion skills. Consequently, in the task of integrating multiple motion skills for humanoid robots, these methods typically require the design of corresponding combinations of reward functions for each different motion skill, which limits the flexibility and scalability of these methods.

In recent years, imitation learning-based methods have been extensively studied and have produced many variants. Imitation learning-based methods can learn different motion skills by referencing different motion capture data, which significantly reduces their reliance on reward engineering and provides them with good flexibility. DeepMimic enables virtual characters in character animation to periodically track reference motion trajectories obtained from retargeting motion capture data, allowing the controller to imitate corresponding actions in the motion trajectories based on input periodic signals; Adversarial Motion Priors (AMP) introduces a Generative Adversarial Imitation Learning (GAIL) framework, where a discriminator network assists the controller's learning by distinguishing between generated actions and reference actions, enabling the controller to learn actions consistent with the style of the reference actions; Adversarial Skill Embedding (ASE) introduces a shared parameter space, which can integrate multiple different sets of motion skills into the shared parameter space in an unsupervised learning manner through information encoding, and uses the shared parameter space as an interface for the integrated motion skills, facilitating subsequent training of corresponding high-level strategies for different tasks through hierarchical reinforcement learning; and building upon ASE, Conditional Adversarial Latent Model (CALM) further introduces an action encoder to map reference action segments into corresponding information encodings, thereby enabling control and switching of the integrated motion skills.

Regarding existing imitation learning-based methods, as trajectory tracking-based methods exemplified by DeepMimic can only periodically track trajectories in reference motion skills and face difficulties in switching between different trajectories, existing methods typically use the GAIL framework as a foundation to improve the flexibility of the trained controller. However, the GAIL framework generally suffers from the problem of mode collapse, meaning the controller may ultimately fail to learn all given reference motion skills completely. This problem also significantly affects the range and quantity of motion skills that existing methods can integrate, limiting their scalability.

In conclusion, existing motion control for humanoid robots at least presents the following issues:
1) reinforcement learning-based methods often rely on complex reward engineering. Therefore, when learning new motion skills, they require corresponding reward design and adjustment, which significantly impacts their flexibility; and
2) imitation learning-based methods typically use the GAIL framework as their foundation. However, the GAIL framework generally suffers from the problem of mode collapse, which limits its scalability.

### SUMMARY

To overcome the deficiencies in the prior art described above, the present invention provides a multi-motion switching control method and system for a humanoid robot based on imitation learning, which enables the humanoid robot to integrate different combinations of motion skills, effectively mitigates the severity of the mode collapse problem, and exhibits good flexibility and scalability.

To achieve the above objective, the following technical solutions are adopted by the present invention.

In a first aspect, the present invention provides a multi-motion switching control method for a humanoid robot based on imitation learning, including:
acquiring a body state of the humanoid robot and a target motion task of the humanoid robot;
inputting the body state of the humanoid robot and the target motion task of the humanoid robot into a pre-built motion control model to obtain a motor torque to be executed by the humanoid robot; and
carrying out a motion control on the humanoid robot using the obtained motor torque to be executed by the humanoid robot, thereby achieving smooth switching between different motion skills of the humanoid robot;
wherein, the pre-built motion control model is a Generative Adversarial Network (GAN) model trained through the imitation learning; and during the training of the GAN model through the imitation learning, a sampling probability for each of the motion skills is dynamically adjusted according to performance of the humanoid robot in executing the motion skills, so that the humanoid robot uniformly masters the different motion skills.

In a second aspect, the present invention provides a multi-motion switching control system for a humanoid robot based on imitation learning, including:
an acquisition module configured to: acquire a body state of the humanoid robot and a target motion task of the humanoid robot;
a motor torque module configured to: input the body state of the humanoid robot and the target motion task of the humanoid robot into a pre-built motion control model to obtain a motor torque to be executed by the humanoid robot;
wherein, the pre-built motion control model is a GAN model trained through the imitation learning; and during the training of the GAN model through the imitation learning, a sampling probability for each of the motion skills is dynamically adjusted according to performance of the humanoid robot in executing the motion skills, so that the humanoid robot uniformly masters the different motion skills; and
a control module configured to: carry out a motion control on the humanoid robot using the obtained motor torque to be executed by the humanoid robot, thereby achieving smooth switching between the different motion skills of the humanoid robot.

In a third aspect, the present invention provides an electronic device, including a memory and a processor, as well as computer instructions stored in the memory and running on the processor, wherein when the computer instructions are executed by the processor, causing the processor to complete the method according to the first aspect.

In a fourth aspect, the present invention provides a non-transitory computer-readable storage medium for storing computer instructions, wherein when the computer instructions are executed by a processor, causing the processor to complete the method according to the first aspect.

The above one or more technical solutions have the following beneficial effects:
according to the present invention, the imitation learning is performed based on a GAN, and the sampling probability for each of the motion skills is dynamically adjusted according to the performance of the humanoid robot in executing the motion skills, so that the humanoid robot uniformly masters the different motion skills; this enables the humanoid robot to integrate different combinations of motion skills, effectively mitigates the severity of the mode collapse problem, and provides good flexibility and scalability.

Additional advantages of the present invention will be partially presented in the following description, some of which will become apparent from the following description, or may be learned through practice of the present invention.

### BRIEF DESCRIPTION OF THE DRAWINGS

The accompanying drawings as a part of the present invention are provided to further illustrate the present invention. The exemplary embodiments of the present invention and their descriptions are intended to explain the present invention and do not constitute an undue limitation thereon.

FIG. 1 is a schematic diagram of an overall framework of a motion control model according to Example I of the present invention; and

FIG. 2 is a motion display diagram of some integrated motion skills of an exemplary humanoid robot according to Example I of the present invention.

### DETAILED DESCRIPTION

It should be noted that the following detailed description is exemplary and aims to further describe the present invention. Unless otherwise specified, all technical and scientific terms used herein have the same meanings as those generally understood by a person of ordinary skill in the art to which the present invention belongs.

It should be noted that the terms used herein are only for describing the embodiments rather than for limiting the exemplary embodiments of the present invention.

The embodiments of the present invention and the features in the embodiments can be combined with each other in case of no conflict.

### Example I

The present example discloses a multi-motion switching control method for a humanoid robot based on imitation learning, including:
acquiring state information of the humanoid robot from a previous time point and a target motion task of the humanoid robot;
inputting the state information of the humanoid robot from the previous time point and the target motion task of the humanoid robot into a pre-built motion control model to obtain a motor torque to be executed by the humanoid robot; and
carrying out a motion control on the humanoid robot using the obtained motor torque to be executed by the humanoid robot, thereby achieving smooth switching between different motion skills of the humanoid robot;
wherein, the pre-built motion control model is a GAN model trained through the imitation learning; and during the training of the GAN model through the imitation learning, a sampling probability for each of the motion skills is dynamically adjusted according to performance of the humanoid robot in executing the motion skills, so that the humanoid robot uniformly masters the different motion skills.

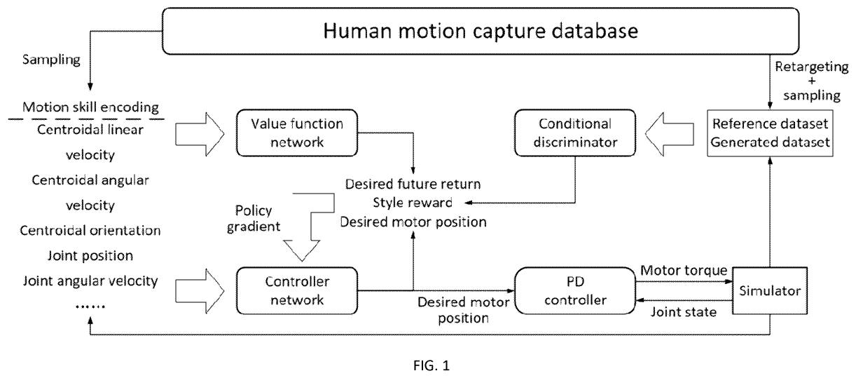

As shown in FIG. 1, the present example uses a motion skill encoding as a conditional input to a controller network, enabling the controller network to separately learn different motion skills by a curriculum learning method during the training process. The overall framework of the motion control model is implemented based on a GAIL framework and an actor-critic reinforcement learning algorithm, including three neural networks: a controller network, a value function network, and a conditional discriminator network.

The actor-critic reinforcement learning algorithm consists of an actor network and a critic network. The actor and critic are explained below.

The actor represents a policy function responsible for outputting a corresponding action based on state input at a current time point. Its objective is to learn an optimal policy to maximize a cumulative reward. During the training process, the actor continuously interacts with the environment, tries different actions, and adjusts its policy based on rewards fed back from the environment, enabling it to select better actions in the future.

The critic represents a value function responsible for evaluating the quality of a current policy. Its objective is to estimate an expected cumulative reward obtainable from a certain state under the current policy. During the training process, the critic observes the interaction process between the actor and the environment, calculates a value of each state, and guides the actor in adjusting its policy based on changes in value.

In the present example, the controller network and the value function network correspond to the actor network and the critic network in the actor-critic reinforcement learning algorithm, respectively. Additionally, this framework requires multiple sets of human motion capture data as reference data, where each set of motion capture data corresponds to a motion skill intended for the humanoid robot to learn. Before training, the reference data needs to be retargeted to the corresponding humanoid robot to form a reference motion capture dataset. Then, for each motion skill in the reference motion capture dataset, a corresponding motion skill one-hot encoding is manually assigned to indicate the type of motion skill.

At each time point during the training process, the overall framework of the motion control model includes the following steps:
S1: the overall framework samples motion skill encodings from the reference motion capture dataset. The sampling result is combined with partial body states of the humanoid robot at a current time point, including a centroidal linear velocity, a centroidal angular velocity, a centroidal orientation, a joint position, and a joint angular velocity, to form observation data, which are then input into the controller network and the value function network respectively;
S2: the controller network receives the input of the observation data at the current time point and outputs an action for the current time point, namely a desired motor position at;
S3: the value function network, based on the input of the observation data at the current time point, outputs its predicted desired future return;
S4: a proportional derivative (PD) controller receives the input of the desired motor position and, combined with a joint state at the current time point, calculates a required motor torque t to be applied. The specific calculation formula is τ=kₚ*(aₜ−θₜ)+k_{d}*\dot{θ}ₜ, where kₚ and k_{d} represent pre-tuned PD parameters whose actual values vary depending on the model of the humanoid robot used; θₜ and \dot{θ}ₜ represent a position and angular velocity of the motor on the current humanoid robot respectively; and at represents the desired motor position output by the controller network for the current time point;
S5: after a simulator executes the motor torque, it returns a body state at a next time point and updates a generated dataset with an actual motion state of the humanoid robot;
S6: a discriminator receives samples from the generated dataset and the reference dataset as input and outputs a probability that these samples belong to the reference dataset. This probability p is used to calculate a style reward r using the formula r=−log (1−p), which represents a similarity between the robot's actual motion state and a reference motion state; and
S7: all the three networks in the framework update their network parameters using a gradient descent method.

All the three networks in the framework are multilayer perceptron (MLP) networks. They all use a backpropagation algorithm combined with an Adam optimizer to update their network parameters. The detailed update methods for each network are as follows:

### 1. Controller Network

In the present example, the controller network can be represented as π_{θ}(a|s, c), where θ represents a network parameter of the controller network; s represents an input state/observation; c represents an input motion skill encoding; and a represents an action output by the controller network based on the input (s, c). The objective of the controller network is to find a network parameter θ* that maximizes the cumulative reward. The policy gradient method involves calculating the gradient of the cumulative reward with respect to the network parameter to update the network parameter, thereby improving the network parameter in the direction that increases the cumulative reward.

To facilitate subsequent description, the cumulative reward is defined as J(θ)=E_{τ˜90}_{_{θ}}_{(τ)}[R(τ)], wherein τ represents a trajectory including a series of states, actions, rewards, and a motion skill encoding corresponding to that trajectory; R(τ) represents a total reward of the trajectory; and E represents an expectation.

A single update process of the controller network is as follows:
(1) calculating the policy gradient:
the policy gradient is calculated by the following formula:

$${∇}_{θ} J ( θ ) = {E}_{τ ∼ {π}_{θ} ( τ )} [ {\sum }_{t = 0}^{T} {∇}_{θ} log {π}_{θ} ( {a}_{t} \vert {s}_{t} , c ) \cdot {Q}^{{π}_{θ}} ( {s}_{t} , {a}_{t} \vert c ) ] ;$$

wherein, T represents a length of the trajectory; and Q^{π}^{_{θ}}(sₜ,aₜ|c) represents an action-value function for a state sₜ and action aₜ under a policy ζ_{θ} with the motion skill encoding c, as estimated by the value function network.
(2) updating the network parameter:
Backpropagation is performed according to the policy gradient and the Adam optimizer is used to update the controller network parameter, i.e., θ=θ+α∇_{θ}J(θ), wherein α represents a learning rate.

### 2. Value Function Network

In the present example, the value function network can be represented as Q_{ω}(s, a|c), wherein ω represents a network parameter of the value function network. The role of the value function network is to estimate an expected cumulative reward that can be obtained by following the action output by the current controller network under a given state, action, and motion skill encoding.

The value function network learns using a temporal difference (TD) method. Its single update process is as follows:

### (1) Calculating a TD Error:

The controller network interacts with the environment to collect a series of data including states, actions, rewards, and next states. These data, combined with the motion skill encoding, form experience samples (sₜ, aₜ, rₜ, sₜ₊₁, c). Based on the experience samples, the TD error is calculated as follows:

$${δ}_{t} = {r}_{t} + γ {Q}_{ω} ( {s}_{t + 1} , {a}_{t + 1} \vert c ) - {Q}_{ω} ( {s}_{t} , {a}_{t} \vert c ) ;$$

wherein, rₜ represents a style reward obtained by the humanoid robot at the current time point, and γ represents a discount factor.

### (2) Updating the Network Parameter:

Backpropagation is performed according to the TD error and the Adam optimizer is used to update the value function network parameter, i.e., ω=ω+α∇_{ω}δₜ, wherein α represents the learning rate.

### 3. Conditional Discriminator Network

In the present example, the conditional discriminator network can be represented as D_{φ}(sₜ, sₜ₊₁|c), wherein φ represents a parameter of the conditional discriminator network; (sₜ, sₜ₊₁) represents a motion state pair at adjacent time points; and c represents the motion skill encoding. The role of the conditional discriminator is to determine the probability p that the input motion state pair at the adjacent time points belongs to the reference dataset, based on the input motion skill encoding. In the present example, the probability value p is used to calculate a style reward using the formula r=−log (1−p).

A single update process of the conditional discriminator network is as follows:

### (1) Calculating a Classification Error Loss:

N samples (sₜ, sₜ₊₁) are sampled from the generated dataset and the reference dataset, along with their corresponding motion skill encodings c. The conditional discriminator network accepts (sₜ, sₜ₊₁, c) as input and outputs the probability p for each sample from the reference dataset. For convenience of expression, let y=1 indicate that the sample comes from the reference dataset, and let y=0 indicate that the sample comes from the generated dataset. The actual source dataset for each sample is known and is denoted as y*. A cross-entropy loss is applied to calculate the classification error loss of the conditional discriminator network:

$$L = - \frac{1}{N} {\sum }_{i = 1}^{N} [ {y}_{i}^{*} log ( {p}_{i} ) + ( 1 - {y}_{i}^{*} ) log ( 1 - {p}_{i} ) ] .$$

### (2) Updating the Network Parameter:

Backpropagation is performed according to the classification error loss and the Adam optimizer is used to update the parameter of the conditional discriminator network, i.e., ω=ω+α∇_{φ}L, where α represents the learning rate.

The conditional discriminator network is used to discriminate whether a motion state pair sample comes from the reference dataset or the generated dataset.

The training process of the conditional discriminator network is as follows:
1) some samples are randomly sampled from both the generated dataset and the reference dataset;
2) these samples are input one by one into the conditional discriminator network, which then outputs the probability of each sample coming from the reference dataset;
3) since whether each sample comes from the reference dataset is known, the classification loss can be calculated based on the network output. As there are only two categories: from the reference dataset and from the generated dataset, the commonly used cross-entropy classification loss is applied; and
4) after the loss is calculated, the Adam optimizer is used for backpropagation to update the network parameter.

The reinforcement learning algorithm used for training the overall framework of the motion control model is Proximal Policy Optimization (PPO). During the training process, the aforementioned S1-S7 are repeated iteratively until the controller network converges.

Wherein, each sample in the generated dataset and the reference dataset in S6 consists of a motion state pair (sₜ, sₜ₊₁) from two adjacent time points of the humanoid robot and a motion skill encoding c corresponding to that motion state pair. The samples in the reference dataset are obtained by random sampling from the reference motion capture dataset, with the sampling probability for each motion skill dynamically adjusted according to a dynamic skill sampling weighting method; the samples in the generated dataset are acquired from the actual motion data of the humanoid robot.

Wherein, in the present example, the reference motion capture dataset refers to the dataset obtained by retargeting human motion capture data onto the humanoid robot; whereas the reference dataset is a dataset composed of motion state pairs sampled from the reference motion capture dataset, where each sample is a motion state pair from adjacent time points.

The detailed construction process of the reference dataset is as follows:
motion capture data typically consist of a series of human motion frames arranged in chronological order. After retargeting the motion capture data onto the humanoid robot, the data composition remains unchanged. Based on this, for each motion skill in the reference motion capture dataset, a corresponding motion skill one-hot encoding is manually assigned to indicate the type of motion skill. At this point, the reference motion capture dataset is considered fully constructed; and
a motion skill encoding c is randomly selected from the reference motion capture dataset, and a series of motion frames (i.e., motion state pairs) from adjacent time points are randomly selected from the motion capture data corresponding to that motion skill. Upon completion of this process, a series of samples is obtained, and these samples all consist of a motion state pair and its corresponding motion skill encoding c; after repeating this step multiple times, the reference dataset is fully constructed.

During the training process of the motion control model, the learning of all motion skills can be understood as occurring alternately, specifically as follows: in each training round, the framework samples a motion skill encoding; there is a one-to-one correspondence between motion skill encodings and motion skills. According to the sampling result, the framework will learn the motion skill corresponding to the sampling result during this training round, where the learning subject includes all steps within that motion skill.

Generally, the humanoid robot requires multiple rounds of training to master each motion skill, and in each training round, each motion skill encoding has a probability of being sampled. Therefore, it can be understood that throughout the entire training process, the learning of all motion skills proceeds alternately. As the number of training rounds continuously increases, the humanoid robot will gradually learn each different motion skill from scratch.

The present example designs a dynamic skill sampling weight to effectively mitigate the severity of the mode collapse problem.

Specifically, during the training process, a mean style reward corresponding to each motion skill is dynamically calculated. For a given motion skill, a higher mean style reward indicates that the current humanoid robot has a better mastery of that motion skill.

According to the calculated mean style reward Rᵢ for the i^{th} motion skill, its probability of being sampled by the framework is updated using the following formula:

$${p}_{i} = \frac{{e}^{{R}_{i}}}{{\sum }_{m ∈ M} {e}^{{R}_{i}}} ;$$

wherein, m represents a motion skill, and M represents a set of all motion skills in the reference motion capture dataset. This method enables the controller network to dynamically adjust its learning tendency towards different motion skills according to their respective mastery levels, ultimately achieving a more comprehensive and balanced mastery of each different motion skill, thereby mitigating the severity of the mode collapse problem.

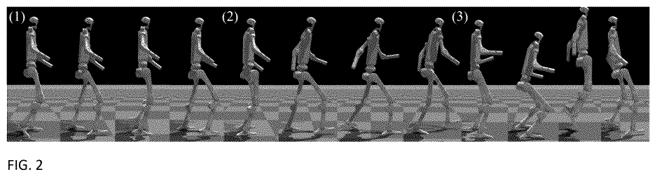

FIG. 2 shows a Unitree H1 humanoid robot used in the present example demonstrating some of its integrated motion skills, specifically: recovering from (1) zombie walk imitation to (2) normal walking, and finally switching to (3) forward jumping.

To conveniently demonstrate the technical effects of the present example, four different motion skill combinations 1-4 were designed, named Dataset 1, Dataset 2, Dataset 3, and Dataset 4 respectively. The contents of Datasets 1-4 were all human motion capture data, containing 10, 7, 6, and 8 different motion skills respectively. Each motion skill sequence was retargeted to the Unitree H1 humanoid robot for subsequent training and learning. Dataset 1 is used as an example below to show the specific motion skills it contains:

TABLE 1
Motion Skills Contained in Dataset 1

| | Length of Motion Capture Data |
|---|---|
| Name of Motion Skill | Sequence (s) |
| Forward Walk | 2.55 |
| Backward Walk | 2.32 |
| Walk Right | 2.32 |
| Walk Left | 2.98 |
| Turn Right | 1.48 |
| Turn Left | 1.15 |
| Turn Right In Place | 1.15 |
| Turn Left In Place | 1.65 |
| Run | 0.83 |
| Jump | 1.65 |

The existing technologies MultiAMP and CALM were selected as comparison objects, and two sets of experiments were designed to evaluate the ability of different methods to comprehensively learn motion skills and the severity of their susceptibility to mode collapse, respectively.

Experiment I: Motion Skill Learning Capability Evaluation Experiment. Motion skill encodings were randomly sampled with equal probability as input to the controller network, collecting a total of 2,000 motion trajectories, each with a length of 200 unit time points (corresponding to 5 s in the real world). For each motion trajectory m*, the motion state pairs at all adjacent time points were used to determine the motion skill categories to which they belong by motion matching (i.e., the following formula, wherein D^{M} represents the reference motion capture dataset; m represents a motion trajectory in the reference motion capture dataset; (sₜ, sₜ₊₁) represents a motion state pair at adjacent time points in the generated dataset; and (sₜ, sₜ₊₁) represents a motion state pair at adjacent time points in the reference dataset):

$${m}^{*} = {arg min}_{m ∈ {D}^{M}} {min}_{( {\overline{s}}_{t} , {\overline{s}}_{t + 1} ) ∈ m} {‖ {s}_{t} - {\overline{s}}_{t} ‖}^{2} + {‖ {s}_{t + 1} - {\overline{s}}_{t + 1} ‖}^{2} .$$

After obtaining the motion skill categories to which all motion state pairs in each motion trajectory belonged, the motion skill category with the highest count in each motion trajectory was determined as the motion skill category to which that trajectory belonged. If at least one motion trajectory was determined to correspond to a motion skill of a certain category, the controller network was considered to have learned that motion skill. The following are the experimental results corresponding to Experiment I, where the motion skill coverage rate is calculated using the following formula:

$$Motion Skill Coverage Rate = \frac{Number of motion skill categories learned by the humanoid robot}{Number of motion skill categories in the dataset} ;$$

wherein, a higher motion skill coverage rate indicates that the corresponding method enables the humanoid robot to learn the corresponding motion skills more comprehensively.

TABLE 2
Motion Skill Coverage Rates Corresponding to Various Methods

| Method | Dataset 1 | Dataset 2 | Dataset 3 | Dataset 4 |
|---|---|---|---|---|
| MultiAMP | 100.00% | 100.00% | 83.33% | 87.50% |
| CALM | 70.00% | 85.71% | 50.00% | 87.50% |
| Method used in the | 100.00% | 100.00% | 100.00% | 100.00% |
| present example | | | | |

From the results of Experiment I, it can be observed that the method used in the present example achieved full coverage learning of motion skills across all of Datasets 1-4, whereas the comparative methods, MultiAMP and CALM, failed to learn all motion skills comprehensively across all datasets. The CALM method additionally introduced a latent variable space and trained a corresponding encoder using an unsupervised learning paradigm, thereby increasing the difficulty of learning motion skills and leading to its poorer performance.

Experiment II: Mode Collapse Severity Evaluation Experiment. Motion skill encodings were randomly sampled with equal probability as input to the controller, collecting a total of 2,000 motion trajectories, each with a length of 200 unit time points (corresponding to 5 s in the real world). These motion trajectories constituted a motion trajectory set T. The Average Pairwise Distance (APD) for T was calculated using the following formula:

$$APD ( T ) = \frac{1}{N ( N - 1 )} {\sum }_{i = 1}^{N} {\sum }_{j \neq i}^{N} {[ {\sum }_{t = 1}^{L} ( {‖ {s}_{t}^{i} - {s}_{t}^{j} ‖}^{2} ) ]}^{\frac{1}{2}} ;$$

wherein, N represents the number of motion trajectories in T; L represents the length of each motion trajectory; and

$${s}_{t}^{i}$$

represents the motion state of the humanoid robot at a time point t in the i^{th} motion trajectory. A larger APD indicates a higher diversity of motion states within the motion trajectories, thereby indirectly indicating a milder degree of mode collapse.

The following are the experimental results corresponding to Experiment II:

TABLE 3
Motion State Diversities Corresponding to Various Methods

| Method | Dataset 1 | Dataset 2 | Dataset 3 | Dataset 4 |
|---|---|---|---|---|
| MultiAMP | 1602.08 | 2071.53 | 1976.12 | 1694.92 |
| CALM | 1519.33 | 1937.30 | 1767.82 | 1522.71 |
| Method used in the | 1883.19 | 2473.32 | 2117.87 | 1802.85 |
| present example | | | | |

From the results of Experiment II, it can be observed that the motion skills ultimately learned by the method used in the present example exhibit more diverse motion states, which indirectly indicates that the method used in the present example can effectively mitigate the mode collapse problem.

In conclusion, the present example constructed four different motion skill combinations and used the Unitree H1 humanoid robot to verify the effectiveness of the method. The experimental results demonstrate that the method used in the present example enables the controller network to comprehensively learn the corresponding motion skills from the given human motion capture dataset and significantly reduces the severity of mode collapse. This is highly beneficial for multi-motion skill integration applications in humanoid robots and will also facilitate the future application of humanoid robots to more scenarios and tasks.

### Example II

The present example is intended to provide a multi-motion switching control system for a humanoid robot based on imitation learning, including:
an acquisition module configured to: acquire a body state of the humanoid robot and a target motion task of the humanoid robot;
a motor torque module configured to: input the body state of the humanoid robot and the target motion task of the humanoid robot into a pre-built motion control model to obtain a motor torque to be executed by the humanoid robot:
wherein the pre-built motion control model is a GAN model trained through the imitation learning; and during the training of the GAN model through the imitation learning, a sampling probability for each motion skill is dynamically adjusted according to performance of the humanoid robot in executing the motion skill, so that the humanoid robot uniformly masters different motion skills; and
a control module configured to: carry out a motion control on the humanoid robot using the obtained motor torque to be executed by the humanoid robot, thereby achieving smooth switching between the different motion skills of the humanoid robot.

In further examples, the followings are also provided:
an electronic device, including: a memory and a processor, as well as computer instructions stored in the memory and running on the processor, wherein when the computer instructions are executed by the processor, causing the processor to complete the method described in Example I. For brevity, it will not be elaborated herein.

It should be understood that in this embodiment, the processor may be a Central Processing Unit (CPU), or the processor may also be another general-purpose processor, a Digital Signal Processor (DSP), an Application Specific Integrated Circuit (ASIC), a Field-Programmable Gate Array (FPGA) or programmable logic device, a discrete gate or transistor logic device, or a discrete hardware component. The general-purpose processor may be a microprocessor, or the processor may also be any conventional processor.

The memory may include a read-only memory and a random access memory, and provides instructions and data to the processor. A portion of the memory may also include a non-volatile random access memory. For example, the memory may also store information about a device type.

A non-transitory computer-readable storage medium for storing computer instructions, wherein when the computer instructions are executed by a processor, causing the processor to complete the method described in Example I.

The method in Example I may be directly implemented by a hardware processor, or by a combination of hardware and software modules in the processor. The software module may reside in a mature storage medium in the field such as a random access memory, a flash memory, a read-only memory, a programmable read-only memory, an electrically erasable programmable memory, or a register. The storage medium is located in the memory, and the processor reads information from the memory and completes the steps of the aforementioned method in combination with its hardware. To avoid repetition, it is not elaborated herein.

A computer program product, including a computer program, wherein the computer program, when executed by a processor, causing the processor to implement the method described in Example I.

The present invention also provides at least one computer program product tangibly stored on a non-transitory computer-readable storage medium. The computer program product includes computer-executable instructions, such as instructions included in program modules, which are executed in a device having a real or virtual processor of a target to execute the processes/method as described above. Typically, the program modules include routines, programs, libraries, objects, classes, components, data structures, etc., that perform particular tasks or implement particular abstract data types. In various embodiments, the functionality of the program modules may be combined or split between the program modules as required. The machine-executable instructions for the program modules may be executed within a local or distributed device. In the distributed device, the program modules may be located in both local and remote storage media.

The computer program code for implementing the method of the present invention may be written in one or more programming languages. This computer program code may be provided to a processor of a general-purpose computer, a special-purpose computer, or other programmable data processing apparatus, such that the program code, when executed by the computer or other programmable data processing apparatus, causes the functions/operations specified in the flowcharts and/or block diagrams to be implemented. The program code may be executed entirely on the computer, partly on the computer, as a stand-alone software package, partly on the computer and partly on a remote computer, or entirely on the remote computer or a server.

In the context of the present invention, computer program code or related data may be carried by any suitable carrier to enable a device, apparatus, or processor to perform the various processes and operations described above. Examples of the carrier include signals, computer-readable media, and so forth. Examples of the signals may include electrical, optical, radio, sound, or other forms of propagated signals, such as carrier waves or infrared signals.

A person of ordinary skill in the art may appreciate that the units and algorithm steps of the various examples described in conjunction with the embodiments can be implemented in electronic hardware, or a combination of computer software and electronic hardware. Whether these functions are performed in hardware or software depends on the specific application and design constraints of the technical solution. A professional technician may use different methods to implement the described functions for each specific application, but such implementation should not be considered beyond the scope of the present application.

Although the embodiments of the present invention have been described above in conjunction with the accompanying drawings, they are not intended to limit the scope of protection of the present invention. Those skilled in the art should understand that, based on the technical solutions of the present invention, various modifications or variations made by those skilled in the art without making creative efforts still fall within the scope of protection of the present invention.

1. A multi-motion switching control method for a humanoid robot based on imitation learning, comprising:
acquiring a body state of the humanoid robot and a target motion task of the humanoid robot;
inputting the body state of the humanoid robot and the target motion task of the humanoid robot into a pre-built motion control model to obtain a motor torque to be executed by the humanoid robot; and
carrying out a motion control on the humanoid robot using the obtained motor torque to be executed by the humanoid robot, thereby achieving smooth switching between different motion skills of the humanoid robot;
wherein the pre-built motion control model is a Generative Adversarial Network (GAN) model trained through the imitation learning; and during the training of the GAN model through the imitation learning, a sampling probability for each of the motion skills is dynamically adjusted according to performance of the humanoid robot in executing the motion skills, so that the humanoid robot uniformly masters the different motion skills;
wherein, the motion control model is built specifically through:
constructing a reference motion capture dataset, wherein each reference motion skill corresponds to a motion skill encoding;
sampling motion skill encodings from the reference motion capture dataset, and combining a sampling result with a body state of the humanoid robot at a current time point to form observation data;
inputting the observation data into a controller network and a value function network respectively to obtain a corresponding desired motor position and a desired future return;
performing a motion according to the desired motor position, returning a body state of the humanoid robot at a next time point, and updating a generated dataset with an actual motion state of the humanoid robot;
obtaining a probability that the generated dataset belongs to the reference motion capture dataset using a conditional discriminator, and calculating a style reward; and
updating parameters of the controller network according to the style reward, the desired future return, and the desired motor position, and repeating the above process until the controller network converges;
the step of dynamically adjusting the sampling probability for each of the motion skills according to the performance of the humanoid robot in executing the motion skills, so that the humanoid robot uniformly masters the different motion skills, specifically comprises:
calculating a mean style reward corresponding to each of the motion skills;
obtaining the sampling probability corresponding to each of the motion skills based on the calculated mean style reward corresponding to each of the motion skills and a sum of mean style rewards corresponding to all motion skills in the reference motion capture dataset; and
enabling the humanoid robot to uniformly master the different motion skills according to the calculated sampling probability corresponding to each of the motion skills.

2. The multi-motion switching control method for the humanoid robot based on the imitation learning of claim 1, wherein the conditional discriminator is trained specifically through:
randomly sampling samples from both the generated dataset and the reference dataset, wherein a sampling probability for each of the motion skills in the reference dataset is dynamically adjusted according to the performance of the humanoid robot in executing the motion skills;
inputting the sampled samples into the conditional discriminator to obtain a probability of each of the samples being input into the reference dataset; and
calculating a classification loss according to the obtained probability of each of the samples being input into the reference dataset, and performing backpropagation using an Adam optimizer to update network parameters of the conditional discriminator.

3. The multi-motion switching control method for the humanoid robot based on the imitation learning of claim 1, wherein a temporal difference method is used for backpropagation, and an Adam optimizer is used for updating value network parameters.

4. The multi-motion switching control method for the humanoid robot based on the imitation learning of claim 1, wherein the body state of the humanoid robot comprises a centroidal linear velocity, a centroidal angular velocity, a centroidal orientation, a joint position, and a joint angular velocity.

5. The multi-motion switching control method for the humanoid robot based on the imitation learning of claim 1, wherein the motion skill encoding is implemented through word embedding or one-hot encoding.

6. A multi-motion switching control system for a humanoid robot based on imitation learning, comprising:
an acquisition module configured to: acquire a body state of the humanoid robot and a target motion task of the humanoid robot;
a motor torque module configured to: input the body state of the humanoid robot and the target motion task of the humanoid robot into a pre-built motion control model to obtain a motor torque to be executed by the humanoid robot, wherein the motion control model is built specifically through:
constructing a reference motion capture dataset, wherein each reference motion skill corresponds to a motion skill encoding;
sampling motion skill encodings from the reference motion capture dataset, and combining a sampling result with a body state of the humanoid robot at a current time point to form observation data;
inputting the observation data into a controller network and a value function network respectively to obtain a corresponding desired motor position and a desired future return;
performing a motion according to the desired motor position, returning a body state of the humanoid robot at a next time point, and updating a generated dataset with an actual motion state of the humanoid robot;
obtaining a probability that the generated dataset belongs to the reference dataset using a conditional discriminator, and calculating a style reward; and
updating parameters of the controller network according to the style reward, the desired future return, and the desired motor position, and repeating the above process until the controller network converges;
wherein the pre-built motion control model is a Generative Adversarial Network (GAN) model trained through the imitation learning; and during the training of the GAN model through the imitation learning, a sampling probability for each motion skill is dynamically adjusted according to performance of the humanoid robot in executing the motion skill, so that the humanoid robot uniformly masters different motion skills, specifically comprising:
calculating a mean style reward corresponding to each motion skill;
obtaining the sampling probability corresponding to each motion skill based on the calculated mean style reward corresponding to each motion skill and a sum of mean style rewards corresponding to all motion skills in the reference motion capture dataset; and
enabling the humanoid robot to uniformly master the different motion skills according to the calculated sampling probability corresponding to each motion skill;
a control module configured to: carry out a motion control on the humanoid robot using the obtained motor torque to be executed by the humanoid robot, thereby achieving smooth switching between different motion skills of the humanoid robot.

7. An electronic device, comprising: a memory and a processor, as well as computer instructions stored in the memory and running on the processor, wherein when the computer instructions are executed by the processor, causing the processor to complete the multi-motion switching control method according to any one of claims 1 to 5.

8. A non-transitory computer-readable storage medium, having computer instructions stored thereon, wherein when the computer instructions are executed by a processor, causing the processor to complete the multi-motion switching control method according to any one of claims 1 to 5.
